(19) United States
(12) Patent Application Publication
(10) Pub. No.: US 2005/0221095 A1
(43) Pub. Date: Oct. 6, 2005

(54) Hard coating agent and film with hard coating

(76) Inventor: Wataru Miyazaki, Saitama (JP)

Correspondence Address: SUGHRUE MION, PLLC, 2100 PENNSYLVANIA AVENUE, N.W., SUITE 800, WASHINGTON, DC, 20037, US

(21) Appl. No.: 10/509,801

(22) PCT Filed: Mar. 28, 2003
(86) PCT No.: PCT/JP03/04008

§ 371 Date: May 13, 2005

(30) Foreign Application Priority Data
Mar. 29, 2002 (JP) 2002-94502

(51) Int. Cl. B32B 27/26; B32B 27/40

(52) U.S. Cl. 428/423.1; 528/44

(57) ABSTRACT

The present invention provides a hard coat agent which comprises (A) an ultraviolet curable substance having 5 to 7 function groups, (B) an urethane acrylate oligomer having 2 to 3 function groups and (C) an oligomer type ultraviolet polymerization initiator. The hard coat film can decrease the curl caused by the heat shrinkage and prevent cracking and peeling of the hard coat layer caused by bending, and therefore, is excellent in bending resistance. Also, the hard coat film is excellent in the adhesion property between the hard coat layer and the substrate, pencil hardness of the hard coat layer and abrasion resistance of the hard coat layer.

### FIELD OF THE TECHNOLOGY

The present invention relates to a hard coat film which can be used as a protective film for liquid crystal display devices, CRT(cathode-ray tube) display devices, plasma display devices, electrochromic display devices, light emitting diode display devices, EL (electroluminescence) display devices et al. and parts of display devices such as touch panels, and can be used as a functional film, and a hard coat agent which can be used in the hard coat film.

### BACKGROUND TECHNOLOGY

In recent years, for protecting various displays et al., the displays have been superimposed with a plastic film. Plastic films which contain a hard coat layer obtained by coating with an active energy ray curable resin and are treated with surface-treatment such as low reflection treatment and antistatic treatment have been used as the protecting plastic films.

However, there were problems that curl of the protecting plastic films was caused by heat treatment in the surface-treatment, and crackings and peelings of hard coat layer in the protecting plastic films were caused by bending at processing of the protecting plastic films.

An object of the present invention is to provide a hard coat film which can decrease the curl caused by the surface-treatment and is excellent in the adhesion property of the hard coat layer, hardness, bending resistance and abrasion resistance, and a hard coat agent which can be used in the hard coat film.

### DISCLOSURE OF THE INVENTION

Extensive investigations undertaken by the present inventors directed to the object described above have led to the discovery that the object can be achieved by forming a hard coat layer on the substrate, wherein the hard coat layer is formed by applying on the substrate with a curable composition containing a specific ultraviolet curable substance and an oligomer type ultraviolet polymerization initiator as a hard coat agent and then curing by ultraviolet ray irradiation to the applied curable composition to obtain the hard coat film.

The present invention thus provides a hard coat agent which comprises (A) an ultraviolet curable substance having 5 to 7 function groups, (B) an urethane acrylate oligomer having 2 to 3 function groups and (C) an oligomer type ultraviolet polymerization initiator.

In another aspect, the present invention provides the hard coat agent as described above, wherein an content ratio of an urethane acrylate oligomer having 2 to 3 function groups of ingredient (B) is 5 to 30 parts by weight against to 100 parts by weight of total amount of ingredient (A) and ingredient (B).

In another more aspect, the present invention provides the hard coat agent as described above, wherein the ultraviolet curable substance having 5 to 7 function groups of ingredient (A) is an ultraviolet curable urethane acrylate oligomer having 5 to 7 function groups or an ultraviolet curable acrylate having 5 to 7 function groups.

In further aspect, the present invention provides a hard coat film which comprises a substrate and a hard coat layer, wherein the hard coat layer is formed by applying on the substrate with the hard coat agent as described above and then curing by ultraviolet ray irradiation to the applied hard coat agent layer.

### BRIEF DESCRIPTION OF THE DRAWING

FIG. 1 shows a plane view and a side view of a fixture for measuring heat curl of a hard coat film.

In the drawing, 1 is a hard coat film, 2 is a circular frame and 3 is a fastener.

### PREFERABLE EMBODIMENT FOR PRACTICING THE INVENTION

The ultraviolet curable substance having 5 to 7 function groups, which is used in the hard coat agent of the present invention, has a property of curing caused by irradiating ultraviolet ray and includes unsaturated monomers having 5 to 7 function groups, oligomers having 5 to 7 function groups, resins having 5 to 7 function groups, or compositions thereof. Examples of the ultraviolet curable substance having 5 to 7 function groups include ultraviolet curable substance having 5 to 7 function groups such as acrylates, urethane acryaltes and polyester acrylates.

The preferable ultraviolet curable acryaltes having 5 to 7 function groups include xylitol penta(meth)acrylate, dipentaerythritol penta(meth)acrylate, dipentaerythritol hexa(meth)acrylate and glyceryl dipentaerythritol hepta(meth)acrylate.

The urethane acrylate is a compound having an urethane bond and an acryl group. The urethane bond is generated by addition reaction of a hydroxyl group with an isocyanate group so that the urethane bond is introduced into the urethane acrylate. The acrylate group is introduced into the urethane acrylate by addition reaction of the hydroxyacrylate.

Examples of the ultraviolet curable urethane acryaltes having 5 to 7 function groups include urethaneacrylates obtained by reacting hydroxyl groups of polyol such as pentaol, hexaol and heptaol with a part of isocyanate groups of polyisocyanate such as diisocyanates to produce an urethane compound having isocyanate groups, and then reacting the urethane compound having isocyanate groups with hydroxyacylate.

The ultraviolet curable substance having 5 to 7 function groups can be utilized by single member or a combination of two or more members.

The urethane acrylate oligomer having 2 to 3 function groups of ingredient (B), which is used in the hard coat agent of the present invention, has a property of curing caused by irradiating ultraviolet ray. The urethane acrylate has the structure described above. Examples of the ultraviolet curable urethane acrylate oligomer having 2 to 3 function groups include urethaneacrylate oligomers obtained by reacting hydroxyl groups of polyol such as diol and triol with a part of isocyanate groups of polyisocyanate such as diisocyanates to produce urethane compound having isocyanate groups, and then reacting the urethane compound having isocyanate groups with hydroxyacylate.

The ultraviolet curable urethane acrylate oligomer having 2 to 3 function groups can be utilized by single member or a combination of two or more members.

The content ratio of the urethane acrylate oligomer having 2 to 3 function groups is preferably 5 to 30 parts by weight, more preferably 7 to 25 parts by weight against to 100 parts by weight of total amount of ingredient (A) and ingredient (B).

In the hard coat agent of the present invention, an oligomer type ultraviolet polymerization initiator is comprised.

The oligomer type ultraviolet polymerization initiator is an ultraviolet polymerization initiator having two or more repeat units having ultraviolet polymerization initiation activity and is preferably an ultraviolet polymerization initiator having 2 to 50 of the repeat units. Examples of the oligomer type ultraviolet polymerization initiator include an oligomer type ultraviolet polymerization initiator represented by formula (1): 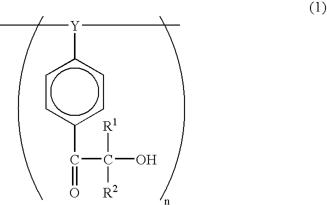
wherein Y is a linear or branched alkylene group, R¹ and R² are a linear or branched alkyl group and may form a ring by bonding each other, and n is an integer of 2 to 50.

The number of carbon atoms in a linear or branched alkylene group of Y is not limited particularly and preferably 1 to 10, more preferably 1 to 6, most preferably 1 to 3. The number of carbon atoms in a linear or branched alkyl group of R¹ and R² is not limited particularly and preferably 1 to 8, more preferably 1 to 5, most preferably 1 to 3. The integer, n, is preferably 2 to 20, more preferably 2 to 10, most preferably 2 to 6.

The terminal of the chain of repeat unit in the oligomer type ultraviolet polymerization initiator are each bonded with a substitution group. The substitution group may be a group derived from an oligomer polymerization initiator or may be a group derived from an oligomer polymerization terminator and includes usually hydrogen atom and hydrocarbon groups. The hydrocarbon groups include, for example, alkyl group, cycloalkyl group and aryl group. Alkyl group includes lower alkyl groups such as methyl group, ethyl group, propyl group and butyl group. Cycloalkyl group includes cyclohexyl group, cycloheptyl group, cyclooctyl group and alkyl group-substituting group thereof. Aryl group includes phenyl group and alkyl group-substituting group thereof.

Examples of the oligomer type ultraviolet polymerization initiator include poly[2-hydroxy-2-methyl-1-{4-(1-methylvinyl)phenyl}propanone], poly[2-hydroxy-2-methyl-1-{4-vinyl-phenyl}propanone], poly[2-hydroxy-2-ethyl-1-{4-(1-methylvinyl)phenyl}propanone], poly[2-hydroxy-2-ethyl-l-{4-vinyl-phenyl}propanone], poly[2-hydroxy-2-methyl-1-{4-(1-methylvinyl)phenyl}butanone], poly[2-hydroxy-2-methyl-1-{4-vinyl-phenyl}butanone], poly[2-hydroxy-2-ethyl-1-{4-(1-methylvinyl)phenyl}butanone] and poly[2-hydroxy-2-ethyl-1-{4-vinyl-phenyl}butanone].

The oligomer type ultraviolet polymerization initiator can be utilized by single member or a combination of two or more members.

The content ratio of the oligomer type ultraviolet polymerization initiator is usually preferably 0.01 to 20 parts by weight, most preferably 0.1 to 10 parts by weight against to 100 parts by weight of total amount of ingredient (A) and ingredient (B).

The hard coat agent of the present invention can be formulated with a filler such as silica, which includes colloid silica, silicone powder, mica, glass bees, acrylic fine powder and hollow particulate to add nonglaring property. The amount of the filler is preferably 0.5 to 50 parts by weight against to 100 parts by weight of the hard coat agent. When the amount of the filler is less than 0.5 parts by weight, the nonglaring property decreases. When the amount of the filler is more than 50 parts by weight, the strength of the film decreases.

The hard coat agent can contain an antimicrobial agent. The antimicrobial agent includes various antimicrobial agents such as silver inorganic antimicrobial agents including silver inorganic antimicrobial agent having zirconium phosphate as a support, silver inorganic antimicrobial agent having zeolite as a support, silver inorganic antimicrobial agent having calcium phosphate as a support, silver inorganic antimicrobial agent having silica gel as a support; amino acid organic antimicrobial agents including organic antimicrobial agent compounded with an amino acid compound; organic antimicrobial agents compounded with a nitrogen-containing sulfur compound.

The amount of the antimicrobial agent can be selected according to the kind of the antimicrobial agent, required antimicrobial property and the holding time et al.

The hard coat agent can contain additives such as a light stabilizer, an ultraviolet absorbent, a catalyst, a coloring agent, an antistatic agent, a lubricant, a leveling agent, a defoaming agent, a polymerization promotor, an antioxidant, a flame retardant, an infrared absorbent, a surface active agent and a surface modifier.

The hard coat agent can contain a diluent for easy application. The diluent includes aromatic hydrocarbons such as benzene, toluene and xylene; aliphatic hydrocarbons such as hexane, heptane, octane, nonane and decane; and ketones such as methyl ethyl ketone, diethyl ketone and diisopropyl ketone. The amount of the diluent can be selected to be the required viscosity.

The substrate film of the hard coat film of the present invention is not limited particularly when the substrate film is transparent or semitransparent, and includes, for example, films such as films of polyester resins, polyethylene resins, polypropylene resins, polystyrene resins, polycarbonate resins or films thereof compounded with filler such as loading material in the range that transparency or semitransparency is not damaged. Polyester resins include preferably polyethylene terephthalate resins and polybutylene terephthalate resins.

A thickness of the substrate film is preferably in a range of from 10 to 350 micrometers, more preferably in a range of from 25 to 300 micrometers, most preferably in a range of from 50 to 250 micrometers.

The surface of the substrate film can be treated for easy adhesion. The easy adhesion treatments are not limited particularly and include a corona discharge treatment and a formation of layer of low molecular weight resin polymer which is the same as the resin of the substrate film. For example, when the substrate film is made of polyester resin, for example, polyethylene terephthalate resin, the low molecular weight resin polymer includes low molecular weight polyesters, for example, ethylene terephthalate oligomers.

The hard coat film of the present invention has the hard coat layer on the surface of the substrate film. The hard coat layer can be formed only one surface or both surfaces of the substrate film.

The hard coat layer can be formed by applying on the substrate with a hard coat agent containing an ultraviolet curable substance and then curing by ultraviolet ray irradiation to the applied hard coat agent.

A thickness of the hard coat layer is not limited particularly and usually preferably in a range of from 1 to 50 micrometers, more preferably in a range of from 2 to 30 micrometers, most preferably in a range of from 3 to 20 micrometers.

In the hard coat film of the present invention, the hard coat agent of the present invention is applied on the substrate and cured by ultraviolet ray irradiation to form the hard coat layer.

Methods of applying the hard coat agent to the substrate film include, for example, conventional known methods such as bar coater method, knife coater method, roll coater method, brad coater method, die coater method, gravure coater method and curtain coater method.

As the irradiated ultraviolet ray, ultraviolet ray radiated from an ultraviolet lamp can be usually used. As the ultraviolet lamp, the ultraviolet lamp such as high-pressure mercury lamp, fusion H lamp and xenon lamp, which emit an ultraviolet ray having a spectrum distribution in the area of 300 to 400 nm of wave length, can be usually used. The irradiation amount is usually in the range of 100 to 500 mJ/m².

The irradiation of ultraviolet ray is preferably carried out under the atmosphere containing no oxygen or low level concentration of oxygen. The oxygen concentration in the low level concentration of oxygen is preferably not more than 5 percents, more preferably not more than 3 percents, and most preferably not more than 2 percents. Gas other than oxygen in the atmosphere containing no oxygen or low level concentration of oxygen, is preferably inactive gas. The inactive gas includes nitrogen, helium, neon and argon.

The hard coat film of the present invention can be used as a protective film for liquid crystal devices, CRT(cathode-ray tube) display devices, plasma display devices, electrochromic display devices, light emitting diode devices, EL (electroluminescence) display devices et al. and parts of display devices such as touch panels, and can be used as a functional film.

For fitting the hard coat film of the present invention to an adherend, a pressure-sensitive adhesive layer can be formed on an opposite surface to the surface of the hard coat layer in the hard coat film.

As a pressure-sensitive adhesive used in the pressure-sensitive adhesive layer, various pressure-sensitive adhesives can be used. The various pressure-sensitive adhesives include, for example, acrylic pressure-sensitive adhesives, silicone pressure-sensitive adhesives, rubber pressure-sensitive adhesives and polyester pressure-sensitive adhesives.

The pressure-sensitive adhesive can contain a tackifier, a filler, a softener, an antioxidant, an ultraviolet absorbent and a curing agent according to needs. The tackifier includes rosin resins, terpene phenol resins, terpene resins, aromatic hydrocarbon modified terpene resins, petroleum resin, coumarone-indene resins, styrene resins, phenol resins and xylene resins. The filler includes zinc white, titanium oxide, silica, calcium carbonate and barium sulfate. The softener includes process oils, liquid rubbers and plasticizers. The antioxidant includes anilide antioxidants, phenol antioxidants, phosphite antioxidants and thioester antioxidants. The ultraviolet absorbent includes benzophenone ultraviolet abosorbents and benzotriazole ultraviolets. The curable agent includes epoxy curable agents, isocyanate curable agents and metallic chelate agents.

The thickness of the pressure-sensitive adhesive layer is usually in the range from 5 to 100 μm, and preferably 10 to 50 μm. For protecting the surface of the pressure-sensitive layer, a release liner is preferably laminated on the surface of the pressure-sensitive layer.

In the hard coat film of the present invention, the substrate film may be printed and then the hard coat layer and the pressure-sensitive adhesive layer may be formed, or the pressure-sensitive adhesive layer may be printed according to needs.

### EXAMPLES

The present invention is described more specifically by reference to embodiments thereof. It should be noted that the present invention is not intended to be limited by these embodiments.

An evaluation method of adhesion property, a measurement method of pencil hardness, a bending resistance test, an abrasion resistance test and a measurement method of heat curl of the hard coat films obtained in examples and comparative examples are described in the following.

(Evaluation Method of Adhesion Property)

A surface of the hard coat layer of the hard coat film was cut by a cutter to form 100 cross hatchings wherein the size of one cross hatching is 1 mm×1 mm and then a cellophane pressure-sensitive adhesive tape (produced by NICHIBAN Co., Ltd.) was adhered on the surface of the hard coat layer. Next, the cellophane pressure-sensitive adhesive tape was peeled from the surface. The adhesion property was evaluated by counting the number of cross hatchings of the hard coat layer left on the substrate. The evaluation of initial adhesion property was conducted by using the hard coat film which was left at room temperature for one day.

(Measurement Method of Pencil Hardness)

The pencil hardness of the surface of the hard coat layer in the hard coat film was measured by using a pencil scratching test machine according to JIS (JAPANESE INDUSTRIAL STANDARD) K5400.

(Bending Resistance Test)

According to JIS K5400, the hard coat film cut in 150 mm×50 mm was bended at angle of about 180° around a shaft having specific diameter, as the surface of the hard coat layer was arranged outside. Next, the hard coat film was returned into the original position. Cracking and peeling of the hard coat layer were observed by visual. Minimum diameter that the cracking and peeling were not caused, was represented as bending resistance (unit: mm).

(Abrasion Resistance Test)

The surface of the hard coat layer was rubbed with Steel wool #0000. Condition of flaw was observed by visual and evaluated according to the following ranking.
◯: flaw was not observed.
×: flaw was observed.
   (Measurement Method of Heat Curl)

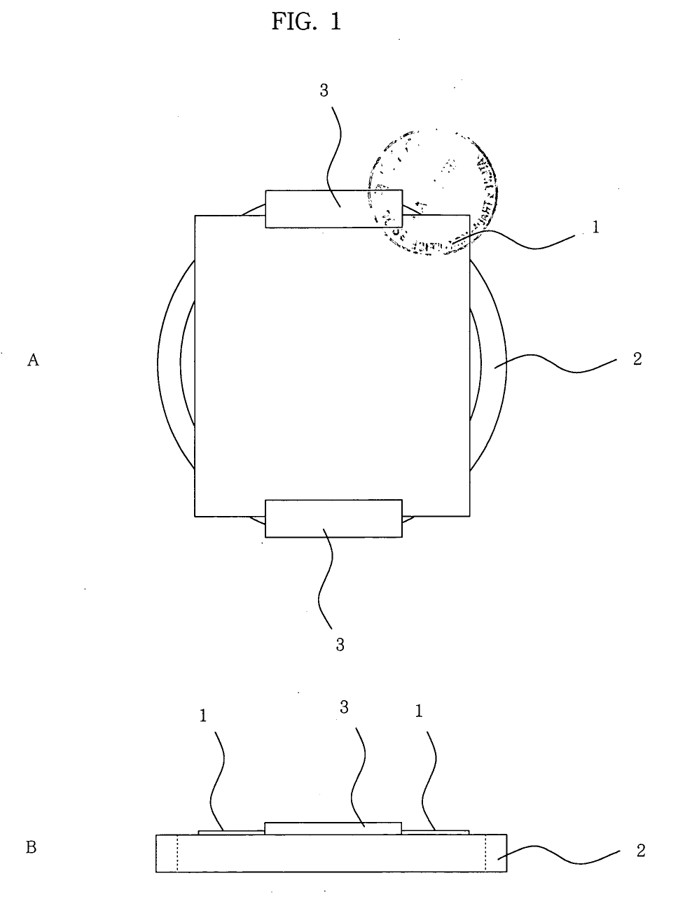

A hard coat film cut in A4 size was fixed to the fixture as shown in FIG. 1 and placed into an oven to heat for 1 minute at 190° C. Next, the hard coat film was cooled to room temperature and then the surface-treated hard coat film was cut in 100 mm×100 mm. The cut hard coat film was placed into an oven under free condition without fixing to the fixture and heated again for 30 minutes at 150° C. And then, the cut hard coat film was left at room temperature. The sample piece was placed on a horizontal bedplate. Each heights of 4 risen sides were measured. Average value of the heights was decided as the measurement value (unit: mm).

### Example 1

Ten parts by weight of urethane acrylate oligomer having two function groups (produced by NIPPON SYNTHETIC CHEMICAL Co., Ltd., trade name “UV-3200”) and 5 parts by weight of poly[2-hydroxy-2-methyl-1-{4-(1-methylvinyl)phenyl}propanone] (produced by LANBELTY CORPORATION, “ESACURE KIP150”, concentration: 100 percents by weight) were added to 90 parts by weight of urethane acrylate oligomer having six function groups (produced by ARAKAWA CHEMICAL Co., Ltd., trade name “BEAMSET 577”, concentration: 100 percents by weight) and mixed. Further, toluene was added to prepare a hard coat agent having 50 percents by weight of resin solid content. Thus, a hard coat agent was prepared.

Next, the hard coat agent was applied by a wire bar on one surface of a polyethylene terephthalate film of a thickness of 188 μm (produced by TOYO BOSEKI Co., Ltd., trade name “A4300”), in which both surfaces were treated to improve adhesion property. And toluene was vaporized to form the hard coat agent layer. And then, ultraviolet ray of high pressure mercury ultraviolet lamp (120 w/cm) was irradiated to the hard coat agent layer from the side of the layer under atmosphere of nitrogen containing about 1 percent of oxygen concentration in the condition of total light volume of about 250 mJ/m². The hard coat agent layer was cured to obtain a hard coat film having a thickness of 5 μm. The adhesion property, the pencil hardness, bending resistance, abrasion resistance and heat curl of the obtained hard coat layer were shown in Table 1.

### Example 2

Twenty parts by weight of urethane acrylate oligomer having two function groups (produced by ARAKAWA CHEMICAL Co., Ltd., trade name “BEAMSET 505B”, concentration: 100 percents by weight) and 5 parts by weight of poly[2-hydroxy-2-methyl-1-{4-(1-methylvinyl)phenyl}propanone] (produced by LANBELTY CORPORATION, “ESACURE KIP150”, concentration: 100 percents by weight) were added to 80 parts by weight of dipentaerythritol hexaacrylate (produced by NIPPON KAYAKU Co., Ltd., “KAYARAD DPHA”, concentration: 100 percents by weight) and mixed. Further, toluene was added to prepare a curable composition having 50 percents by weight of resin solid content. Thus, a hard coat agent was prepared.

Next, the hard coat agent was applied by a wire bar on one surface of a polyethylene terephthalate film of a thickness of 188 μm (produced by TOYO BOSEKI Co., Ltd., trade name “A4300”), in which both surfaces were treated to improve adhesion property. And toluene was vaporized to form the hard coat agent layer. And then, ultraviolet ray of high pressure mercury ultraviolet lamp (120 w/cm) was irradiated to the hard coat agent layer from the side of the layer under atmosphere of nitrogen containing about 1 percent of oxygen concentration in the condition of total light volume of about 250 mJ/m . The hard coat agent layer was cured to obtain a hard coat film having a thickness of 5 μm. The adhesion property, the pencil hardness, bending resistance, abrasion resistance and heat curl of the obtained hard coat layer were shown in Table 1.

### Comparative Example 1

Five parts by weight of poly[2-hydroxy-2-methyl-1-{4-(1-methylvinyl)phenyl}propanone] (produced by LANBELTY CORPORATION, “ESACURE KIP150” concentration: 100 percents by weight) were added to 100 parts by weight of urethane acrylate oligomer having six function groups (produced by ARAKAWA CHEMICAL Co., Ltd., trade name “BEAMSET 577”, concentration: 100 percents by weight) and mixed. Further, toluene was added to prepare a hard coat agent having 50 percents by weight of resin solid content. Thus, a hard coat agent was prepared.

Next, the hard coat agent was applied by a wire bar on one surface of a polyethylene terephthalate film of a thickness of 188 μm (produced by TOYO BOSEKI Co., Ltd., trade name “A4300”), in which both surfaces were treated to improve adhesion property. And toluene was vaporized to form the hard coat agent layer. And then, ultraviolet ray of high pressure mercury ultraviolet lamp (120 w/cm) was irradiated to the hard coat agent layer from the side of the layer under atmosphere of nitrogen containing about 1 percent of oxygen concentration in the condition of total light volume of about 250 mJ/m². The hard coat agent layer was cured to obtain a hard coat film having a thickness of 5 μm. The adhesion property, the pencil hardness, bending resistance, abrasion resistance and heat curl of the obtained hard coat layer were shown in Table 1.

### Comparative Example 2

Ten parts by weight of urethane acrylate oligomer having two function groups (produced by NIPPON SYNTHETIC CHEMICAL Co., Ltd., trade name “UV-3200”) and 5 parts by weight of 1-hydroxy-cyclohexyl-phenyl-ketone (produced by CHIBA GIGY CORPORATION, “IRGACURE 184”) were added to 90 parts by weight of urethane acrylate oligomer having six function groups (produced by ARAKAWA CHEMICAL Co., Ltd., tradename “BEAMSET577”, concentration: 100 percents by weight) and mixed. Further, toluene was added to prepare a hard coat agent having 50 percents by weight of resin solid content. Thus, a hard coat agent was prepared.

Next, the hard coat agent was applied by a wire bar on one surface of a polyethylene terephthalate film of a thickness of 188 μm (produced by TOYO BOSEKI Co., Ltd., trade name “A4300”), in which both surfaces were treated to improve adhesion property. And toluene was vaporized to form the hard coat agent layer. And then, ultraviolet ray of high pressure mercury ultraviolet lamp (120 w/cm) was irradiated to the hard coat agent layer from the side of the layer under atmosphere of nitrogen containing about 1 percent of oxygen concentration in the condition of total light volume of about 250 mJ/m². The hard coat agent layer was cured to obtain a hard coat film having a thickness of 5 μm. The adhesion property, the pencil hardness, bending resistance, abrasion resistance and heat curl of the obtained hard coat layer were shown in Table 1.

### Comparative Example 3

Five parts by weight of poly[2-hydroxy-2-methyl-1-{4-(1-methylvinyl)phenyl}propanone] (produced by LANBELTY CORPORATION, “ESACURE KIP150”, concentration: 100 percents by weight) were added to 100 parts by weight of dipentaerythritol hexaacrylate (produced by NIPPON KAYAKU Co., Ltd., “KAYARAD DPHA”, concentration: 100 percents by weight) and mixed. Further, toluene was added to prepare a curable composition having 50 percents by weight of resin solid content. Thus, a hard coat agent was prepared.

Next, the curable composition was applied by a wire bar on one surface of a polyethylene terephthalate film of a thickness of 188 μm (produced by TOYO BOSEKI Co., Ltd., tradename “A4300”), in which both surfaces were treated with low molecular weight polyester resin to improve adhesion property. And toluene was vaporized to form the curable composition layer having a thickness of 3 μm. And then, ultraviolet ray of high pressure mercury ultraviolet lamp (120 w/cm) was irradiated to the curable composition layer from the side of the layer in the condition of total light volume of about 250 mJ/m². The curable composition layer was cured to obtain a hard coat film. The adhesion property and the gas generation in heat treatment of the hard coat film and the pencil hardness of the hard coat layer were shown in Table 1.

TABLE 1

| | Adhesion | Pencil | Bending | Abrasion | Heat |
|---|---|---|---|---|---|
| | property | hardness | resistance | resistance | curl |
| Example 1 | 100/100 | 2H | 10 | ◯ | 8 |
| Example 2 | 100/100 | 2H | 10 | ◯ | 10 |
| Comparative | 100/100 | 2H | 18 | ◯ | 25 |
| Example 1 | | | | | |
| Comparative | 100/100 | 2H | 14 | ◯ | 9 |
| Example 2 | | | | | |
| Comparative | 100/100 | 2H | 19 | ◯ | 29 |
| Example 3 | | | | | |

The hard coat film of the present invention can decrease the curl caused by the heat shrinkage and prevent cracking and peeling of the hard coat layer caused by bending, and therefore, is excellent in bending resistance. Also, the hard coat film is excellent in the adhesion property between the hard coat layer and the substrate, pencil hardness of the hard coat layer and abrasion resistance of the hard coat layer.

1. A hard coat agent which comprises (A) an ultraviolet curable substance having 5 to 7 function groups, (B) an urethane acrylate oligomer having 2 to 3 function groups and (C) an oligomer type ultraviolet polymerization initiator.

2. The hard coat agent as claimed in claim 1, wherein a content ratio of an rethane acrylate oligomer having 2 to 3 function groups of ingredient (B) is 5 to 30 parts by weight against to 10 parts by weight of total amount of ingredient (A) and ingredient (B).

3. The hard coat agent as claimed in claim 1, wherein the ultraviolet curable substance having 5 to 7 function groups of ingredient (A) is an ultraviolet curable urethane acrylate oligomer having 5 to 7 function groups or an ultraviolet curable acrylate having 5 to 7 function groups.

4. A hard coat film which comprises a substrate and a hard coat layer, wherein the hard coat layer is formed by applying on the substrate with the hard coat agent as claimed in anyone of claims 1 to 3 and then curing by ultraviolet ray irradiation to the applied hard coat agent layer.
